(19) United States
(12) Patent Application Publication
(10) Pub. No.: US 2014/0061466 A1
(43) Pub. Date: Mar. 6, 2014

(54) CONTROLLING ASSEMBLY AND ELECTRONIC DEVICE

(71) Applicants: Chih-Ling Chien, Taoyuan County (TW); Shih-Hsun Ou, Taoyuan County (TW); Chien-Wei Huang, Taoyuan County (TW)

(72) Inventors: Chih-Ling Chien, Taoyuan County (TW); Shih-Hsun Ou, Taoyuan County (TW); Chien-Wei Huang, Taoyuan County (TW)

(73) Assignee: HTC CORPORATION, Taoyuan City (TW)

(21) Appl. No.: 13/597,267

(22) Filed: Aug. 29, 2012

(51) Int. Cl. G01J 1/04

(52) U.S. Cl. CPC G01J 1/0403
USPC 250/338.1

(57) ABSTRACT

A controlling assembly is disclosed, which is adapted to be disposed at a casing, in which the casing has an opening. The controlling assembly includes an infrared transmission module (IR transmission module), a pressing switch and a button. The IR transmission module is adapted to be disposed in the casing and corresponding to the opening. The pressing switch is adapted to be disposed in the casing. The button is adapted to be movably disposed on the casing and shield the opening, in which the button has transparency. The IR transmission module is adapted to transmit or receive infrared light via the opening and passing through the button and the pressing switch is able to be triggered by pressing the button. The invention also discloses an electronic device which includes a casing and a controlling assembly.

### BACKGROUND OF THE INVENTION

1. Field of the Invention

The invention generally relates to a controlling assembly, and more particularly, to an electronic device using the controlling assembly.

2. Description of Related Art

In recent years, along with the increasingly developments of the technology industry, electronic products such as mobile phones, tablet computer, notebook computer and smart phones become more and more popular. The electronic products are developing towards convenient usage, multi-functions and aesthetically pleasing design direction so as to provide users with more option selections.

In addition to the functions of electronic products themselves, an electronic product can also enable the user controlling other external devices by manipulating the electronic product itself through a built-in control program and an IR (infrared) transmission module, which expands the application of the electronic product. When the IR transmission module is disposed in the electronic product, the casing of the electronic product requires to have corresponding hole to allow the transmitted infrared light passing through. However, disposing the hole may damage the appearance and shaping of the electronic product.

### SUMMARY OF THE INVENTION

Accordingly, the invention is directed to a controlling assembly able to reduce the number of the holes on the casing of an electronic product.

The invention is also directed to an electronic device, in which the casing has fewer outward holes.

The invention provides a controlling assembly, which is adapted to be disposed at a casing, in which the casing has an opening. The controlling assembly includes an infrared transmission module (IR transmission module), a pressing switch and a button. The IR transmission module is adapted to be disposed in the casing and corresponding to the opening. The pressing switch is adapted to be disposed in the casing. The button is adapted to be movably disposed on the casing and shield the opening, in which the button has transparency. The IR transmission module is adapted to transmit or receive infrared light via the opening and passing through the button and the pressing switch is able to be triggered by pressing the button.

The invention further provides an electronic device, which includes a casing and a controlling assembly. The casing has an opening and the controlling assembly is disposed at the casing. The controlling assembly includes an IR transmission module, a pressing switch and a button. The IR transmission module is disposed in the casing and corresponding to the opening. The pressing switch is disposed in the casing. The button is movably disposed on the casing and shields the opening, in which the button has transparency. The IR transmission module transmits or receives infrared light via the opening and passing through the button and the pressing switch is able to be triggered by pressing the button.

In an embodiment of the present invention, the above-mentioned controlling assembly further includes a circuit board adapted to be disposed in the casing, in which the IR transmission module and the pressing switch are disposed at the circuit board.

In an embodiment of the present invention, the above-mentioned button has a pressing portion and a contacting portion, the pressing portion is adapted to be exposed at the casing and accept an external force, and when the pressing portion drives the contacting portion due to the pressing of the external force, the contacting portion triggers the pressing switch.

In an embodiment of the present invention, the above-mentioned controlling assembly further includes a circuit board disposed in the casing, in which the IR transmission module and the pressing switch are disposed at the circuit board.

In an embodiment of the present invention, the above-mentioned circuit board has two side-surfaces opposite to each other, and the IR transmission module and the pressing switch are respectively disposed at the two side-surfaces of the circuit board.

In an embodiment of the present invention, the above-mentioned circuit board has two side-surfaces opposite to each other, and the IR transmission module and the pressing switch are disposed at one of the two side-surfaces of the circuit board.

In an embodiment of the present invention, the above-mentioned button has a pressing portion and a contacting portion, the pressing portion is exposed at the casing and accepts an external force, and when the pressing portion drives the contacting portion due to the pressing of the external force, the contacting portion triggers the pressing switch.

In an embodiment of the present invention, the above-mentioned button includes a fixing end and a free end, the fixing end is fixed on the casing, the pressing portion and the contacting portion are located at the free end, and when the pressing portion drives the contacting portion due to the pressing of the external force, the free end is able to move relatively to the fixing end to make the contacting portion trigger the pressing switch.

In an embodiment of the present invention, the portion of the above-mentioned button for shielding the opening is able to allow infrared light passing through but to block visible light.

Based on the description above, the invention provides a controlling assembly and an electronic device, in which the IR transmission module and the pressing switch are disposed in the casing of the electronic device and the IR transmission module is corresponding to the opening of the casing. The button is movable disposed on the casing and has transparency. The IR transmission module transmits or receives infrared light via the opening and passing through the button, and the pressing switch can be triggered by pressing the button. In this way, the number of the holes can be reduced by the design of the controlling assembly so that the electronic device has fewer outward holes.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a partial side-view diagram of an electronic device according to the first embodiment of the invention.

FIG. 2 is a partial perspective diagram of the electronic device of FIG. 1.

FIG. 3 is a cross-sectional diagram of the controlling assembly of FIG. 1 in angle of side-view.

FIG. 4 is a partial side-view diagram of an electronic device according to the second embodiment of the invention.

FIG. 5 is a partial perspective diagram of the electronic device of FIG. 4.

FIG. 6 is a partial top-view diagram of the electronic device of FIG. 4.

FIG. 7 is a cross-sectional diagram of the controlling assembly of FIG. 4 in angle of side-view.

FIG. 8 is a partial side-view diagram of an electronic device according to the third embodiment of the invention.

FIG. 9 is a partial perspective diagram of the electronic device of FIG. 8.

FIG. 10 is a cross-sectional diagram of the controlling assembly of FIG. 8 in angle of side-view.

FIG. 11 is a partial side-view diagram of an electronic device according to the fourth embodiment of the invention.

FIG. 12 is a partial perspective diagram of the electronic device of FIG. 11.

FIG. 13 is a partial top-view diagram of the electronic device of FIG. 11.

FIG. 14 is a cross-sectional diagram of the controlling assembly of FIG. 11 in angle of side-view.

### DESCRIPTION OF THE EMBODIMENTS

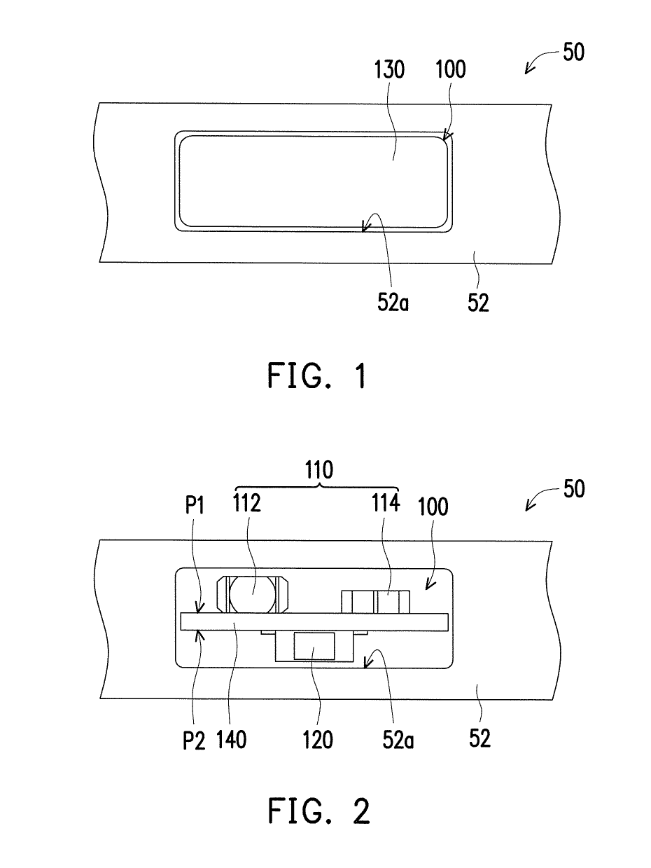

FIG. 1 is a partial side-view diagram of an electronic device according to the first embodiment of the invention and FIG. 2 is a partial perspective diagram of the electronic device of FIG. 1. Referring to FIGS. 1 and 2, in the embodiment, an electronic device 50 includes a casing 52 and a controlling assembly 100. The controlling assembly 100 is disposed at the casing 52. The casing 52 has an opening 52a so that a portion of the controlling assembly 100 is exposed at the casing 52 via the opening 52a. The electronic device 50 is, for example, mobile phone or smart phone, while the casing 52 is the casing of the mobile phone or the smart phone, but the invention does not limited the type of the electronic device 50.

In the embodiment, the controlling assembly 100 includes an IR transmission module 110, a pressing switch 120 and a button 130. The IR transmission module 110 includes a transmitting component 112 and a receiving component 114, but in other embodiments, the transmitting component and the receiving component can be integrated. The pressing switch 120 is, for example, a power key switch and the button 130 is, for example, a power key button, which the invention is not limited to. The IR transmission module 110 is disposed in the casing 52 and corresponding to the opening 52a. The pressing switch 120 is disposed in the casing 52. In the embodiment, the pressing switch 120 is also corresponding to the opening 52a, which the invention is not limited to. Thereby, the pressing switch 120 can be triggered by pressing the button 130.

On the other hand, the button 130 is movably disposed on the casing 52 and shields the opening 52a. When the button 130 is assumed to be removed from the casing 52 and exposes the opening 52a, the IR transmission module 110 is exposed out of the casing 52 via the opening 52a. In the embodiment, the button 130 has transparency. In more details, the portion of the button 130 shielding the opening 52a allows the infrared light to pass through and blocks the visible light.

Therefore, when the button 130 is disposed on the casing 52 and shields the opening 52a, the IR transmission module 110 can transmit or receive the infrared light via the opening 52a and passing through the button 130. At the time, the user is unable to observe the IR transmission module 110 and the pressing switch 120 located in the casing 52 from out of the casing 52. In other embodiments however, the button 130 can be made of transparent material or other material with certain transparency, which the invention is not limited to.

Specifically in the embodiment, the controlling assembly 100 further includes a circuit board 140 disposed in the casing 52, and the IR transmission module 110 and the pressing switch 120 are disposed at the circuit board 140. The circuit board 140 further has two side-surfaces P1 and P2 opposite to each other and the IR transmission module 110 and the pressing switch 120 are respectively disposed at the two side-surfaces P1 and P2 of the circuit board.

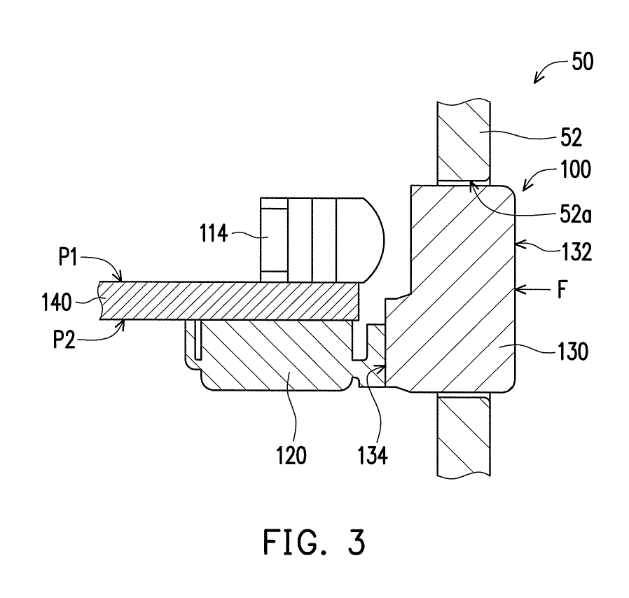

FIG. 3 is a cross-sectional diagram of the controlling assembly of FIG. 1 in angle of side-view. Referring to FIGS. 2 and 3, in the embodiment, the button 130 has a pressing portion 132 and a contacting portion 134. The pressing portion 132 is exposed at the casing 52 and adapted to accept an external force F. When the pressing portion 132 is pressed by the external force F and drives the contacting portion 134, the contacting portion 134 triggers the pressing switch 120. Thus, the user can apply the external force F onto the button 130 by pressing the pressing portion 132 exposed at the casing 52 so as to drive the contacting portion 134 of the button 130 to trigger the pressing switch 120 in pushing way or other ways.

It can be seen that the casing 52 of the electronic device 50 is able to enable the IR transmission module 110 to transmit or receive infrared light via the opening 52a and passing through the button 130 and makes the pressing switch 120 to be triggered by pressing the button 130 both through one opening 52a. The controlling assembly 100 thereby can reduce the number of the holes so that the electronic device 50 has fewer outward holes.

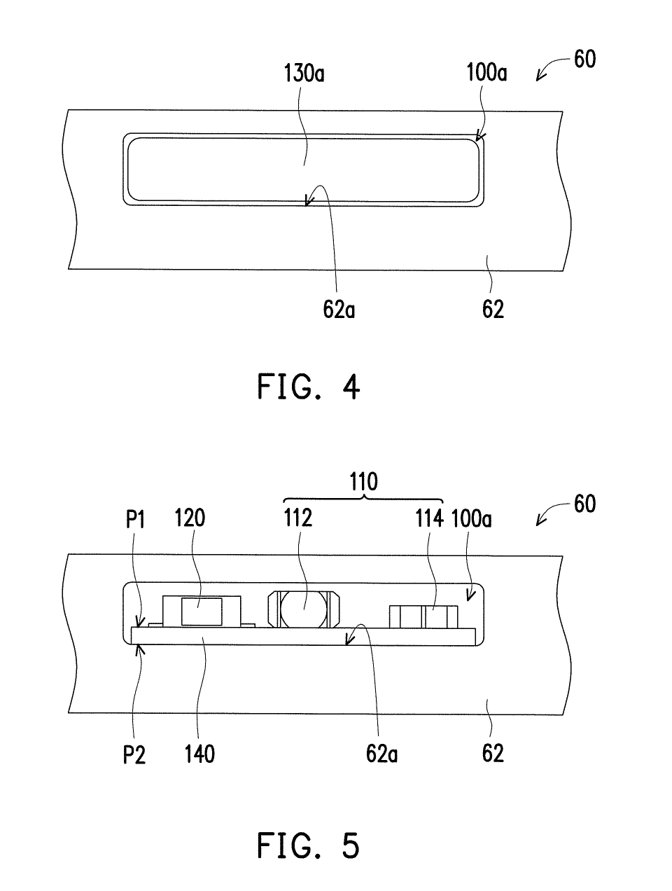

FIG. 4 is a partial side-view diagram of an electronic device according to the second embodiment of the invention and FIG. 5 is a partial perspective diagram of the electronic device of FIG. 4. Referring to FIGS. 4 and 5, in the embodiment, an electronic device 60 includes a casing 62 and a controlling assembly 100a. The controlling assembly 100a is disposed at the casing 62. The casing 62 has an opening 62a so that a portion of the controlling assembly 100a is exposed at the casing 62 via the opening 62a.

In the embodiment, the major difference of the controlling assembly 100a from the controlling assembly 100 rests in that the IR transmission module 110 and the pressing switch 120 of the controlling assembly 100a are disposed at one of the two side-surfaces P1 and P2 of the circuit board 140, i.e., at the side-surface P1, and are respectively corresponding to the opening 62a. Therefore, the arrangement length of the IR transmission module 110 and the pressing switch 120 gets longer and the arrangement height gets lower. In addition, all the parts in the embodiment with the same notations as the ones of the first embodiment have the similar functions and usage ways and they can refer to the description of the first embodiment for understanding.

It can be seen that the shape of the opening 62a at the casing 62 of the electronic device 60, in comparison with the opening 52a at the casing 52 of the electronic device 50, gets narrower but longer, and the button 130a of the controlling assembly 100a is in long-bar shape. Accordingly, the controlling assembly 100a is adapted to apply in the electronic device 60 with a thinner thickness. In other embodiments, the IR transmission module 110 and the pressing switch 120 can be disposed at another side-surface P2 of the circuit board 140, which the invention is not limited to.

In the same way, the button 130a has transparency. In more details, the portion of the button 130a shielding the opening 62a allows the infrared light to pass through and blocks the visible light. Therefore, when the button 130a is disposed on the casing 62 and shields the opening 62a, the IR transmission module 110 can transmit or receive the infrared light via the opening 62a and passing through the button 130a. At the time, the user is unable to observe the IR transmission module 110 and the pressing switch 120 located in the casing 62 from out of the casing 62.

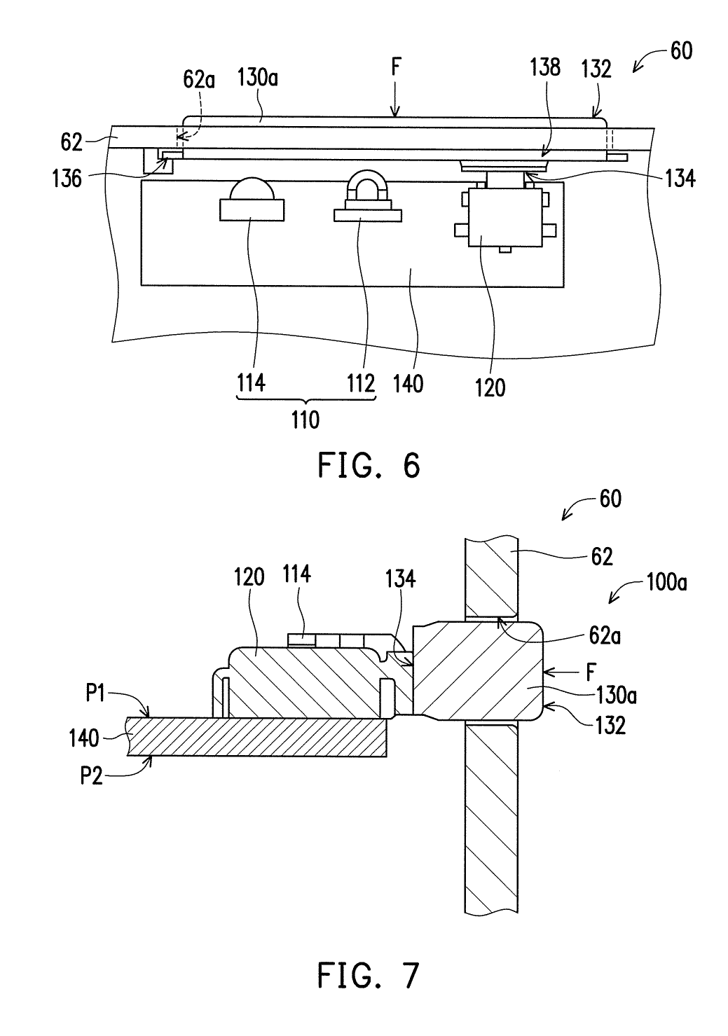

FIG. 6 is a partial top-view diagram of the electronic device of FIG. 4 and FIG. 7 is a cross-sectional diagram of the controlling assembly of FIG. 4 in angle of side-view. Referring to FIGS. 6 and 7, in the embodiment, the button 130a has also a pressing portion 132 and a contacting portion 134. The button 130a further includes a fixing end 136 and a free end 138. The fixing end 136 is fixed on the casing 62, and the pressing portion 132 and the contacting portion 134 are located at the free end 138.

The pressing portion 132 is exposed at the casing 62 and adapted to accept an external force F. When the pressing portion 132 is pressed by the external force F and drives the contacting portion 134, the free end 138 can move relatively to the fixing end 136 to trigger the pressing switch 120 by the contacting portion 134. Thus, the user can apply the external force F onto the button 130a by pressing the pressing portion 132 exposed at the casing 62 so as to drive the contacting portion 134 of the button 130a to trigger the pressing switch 120 in pushing way or other ways by the movement of the free end 138 relatively to the fixing end 136.

It can be seen that the casing 62 of the electronic device 60 is able to enable the IR transmission module 110 to transmit or receive infrared light via the opening 62a and passing through the button 130a and makes the pressing switch 120 to be triggered by pressing the button 130a both through one opening 62a. The controlling assembly 100a thereby can reduce the number of the holes so that the electronic device 60 has fewer outward holes.

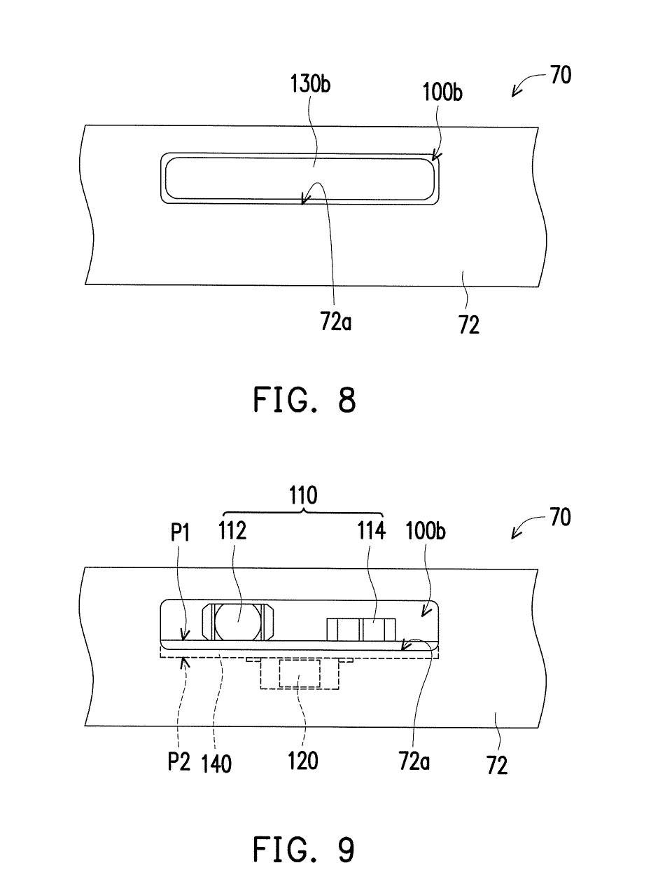

FIG. 8 is a partial side-view diagram of an electronic device according to the third embodiment of the invention and FIG. 9 is a partial perspective diagram of the electronic device of FIG. 8. Referring to FIGS. 8 and 9, in the embodiment, an electronic device 70 includes a casing 72 and a controlling assembly 100b. The controlling assembly 100b is disposed at the casing 72. The casing 72 has an opening 72a so that a portion of the controlling assembly 100b is exposed at the casing 72 via the opening 72a.

In the embodiment, the disposing of the controlling assembly 100b is similar to the controlling assembly 100. All the parts in the embodiment with the same notations as the ones of the first embodiment have the similar functions and usage ways and they can refer to the description of the first embodiment for understanding. The major difference of the controlling assembly 100b from the controlling assembly 100 rests in that the pressing switch 120 is disposed in the casing 72 but not corresponding to the opening 72a. In other words, when the button 130b is assumed to be removed from the casing 72 and exposes the opening 72a, the IR transmission module 110 is exposed out of the casing 72 via the opening 72a, but the pressing switch 120 is hidden in the casing 72.

It can be seen that in the embodiment, the controlling assembly 100b, same as the controlling assembly 100, makes the IR transmission module 110 and the pressing switch 120 disposed at the two side-surfaces P1 and P2 opposite to each other, but the pressing switch 120 is not corresponding to the opening 72a. As a result, the area of the opening 72a is smaller than the opening 52a. That is to say, the required size of the opening 72a is that it can expose the IR transmission module 110 only. Accordingly, the area of the button 130b of the controlling assembly 100b is also reduced. Therefore, the electronic device 70 has smaller area of the opening.

In the same way, the button 130b has transparency. In more details, the portion of the button 130b shielding the opening 72a allows the infrared light to pass through and blocks the visible light. Therefore, when the button 130b is disposed on the casing 72 and shields the opening 72a, the IR transmission module 110 can transmit or receive the infrared light via the opening 72a and passing through the button 130b. At the time, the user is unable to observe the IR transmission module 110 located in the casing 72 from out of the casing 72.

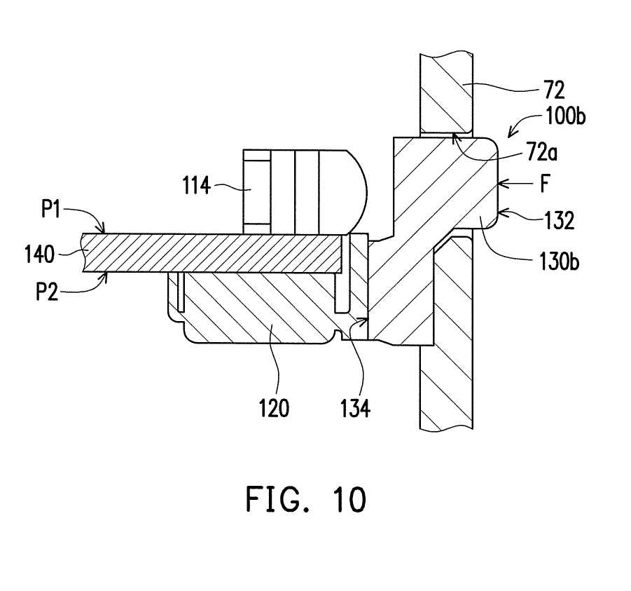

FIG. 10 is a cross-sectional diagram of the controlling assembly of FIG. 8 in angle of side-view. Referring to FIGS. 9 and 10, in the embodiment, the button 130b has also a pressing portion 132 and a contacting portion 134. The pressing portion 132 is exposed at the casing 72 and adapted to accept an external force F, and the contacting portion 134 is located at the underside of the button 130b to be corresponding to the pressing switch 120. In other words, the contacting portion 134 can be considered to be formed by the button 130b located at the opening 72a extending into the casing 72 toward the position under the IR transmission module 110 corresponding to the opening 72a.

When the pressing portion 132 is pressed by the external force F and drives the contacting portion 134, the contacting portion 134 triggers the pressing switch 120. Thus, the user can apply the external force F onto the button 130b by pressing the pressing portion 132 exposed at the casing 72 so as to drive the contacting portion 134 of the button 130b to trigger the pressing switch 120 in pushing way or other ways.

It can be seen that the casing 72 of the electronic device 70 is able to enable the IR transmission module 110 to transmit or receive infrared light via the opening 72a and passing through the button 130b and makes the pressing switch 120 to be triggered by pressing the button 130b both through one opening 72a. The controlling assembly 100b thereby can reduce the number of the holes so that the electronic device 70 has fewer outward holes.

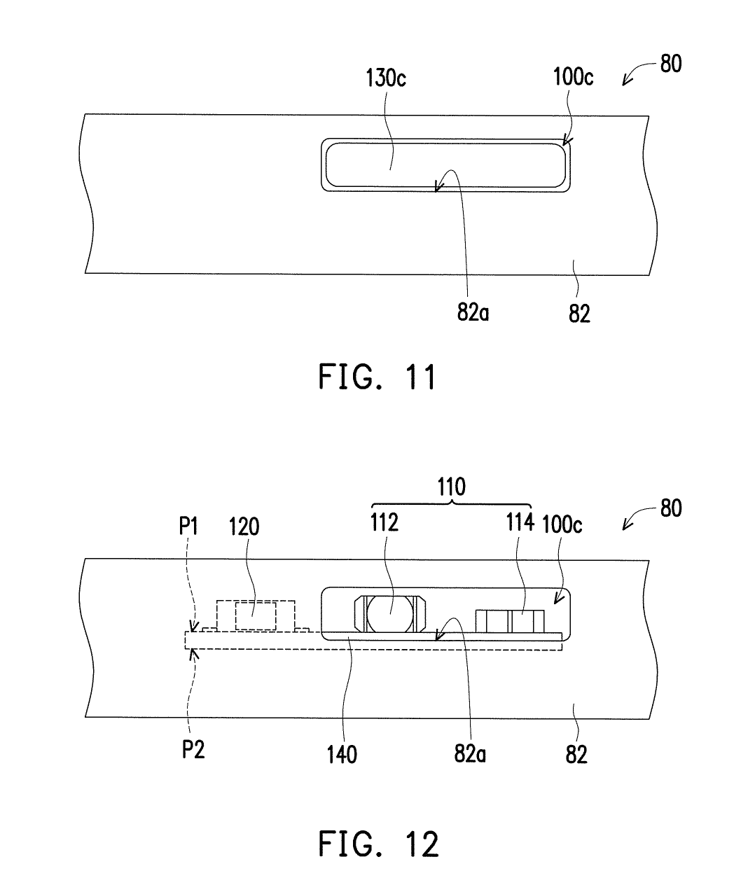

FIG. 11 is a partial side-view diagram of an electronic device according to the fourth embodiment of the invention and FIG. 12 is a partial perspective diagram of the electronic device of FIG. 11. Referring to FIGS. 11 and 12, in the embodiment, an electronic device 80 includes a casing 82 and a controlling assembly 100c. The controlling assembly 100c is disposed at the casing 82. The casing 82 has an opening 82a so that a portion of the controlling assembly 100c is exposed at the casing 82 via the opening 82a.

In the embodiment, the disposing of the controlling assembly 100c is similar to the controlling assembly 100a. All the parts in the embodiment with the same notations as the ones of the second embodiment have the similar functions and usage ways and they can refer to the description of the second embodiment for understanding. The major difference of the controlling assembly 100c from the controlling assembly 100a rests in that the pressing switch 120 is disposed in the casing 82 but not corresponding to the opening 82a. In other words, when the button 130c is assumed to be removed from the casing 82 and exposes the opening 82a, the IR transmission module 110 is exposed out of the casing 82 via the opening 82a, but the pressing switch 120 is hidden in the casing 82.

It can be seen that in the embodiment, the controlling assembly 100c, same as the controlling assembly 100a, makes the IR transmission module 110 and the pressing switch 120 disposed at the same side-surface P1, but the pressing switch 120 is not corresponding to the opening 82a. As a result, the area of the opening 82a is smaller than the opening 62a. That is to say, the required size of the opening 82a is that it can expose the IR transmission module 110 only. Accordingly, the area of the button 130c of the controlling assembly 100c is also reduced. Therefore, the electronic device 80 has smaller area of the opening.

In the same way, the button 130c has transparency. In more details, the portion of the button 130c shielding the opening 82a allows the infrared light to pass through and blocks the visible light. Therefore, when the button 130c is disposed on the casing 82 and shields the opening 82a, the IR transmission module 110 can transmit or receive the infrared light via the opening 82a and passing through the button 130c. At the time, the user is unable to observe the IR transmission module 110 located in the casing 82 from out of the casing 82.

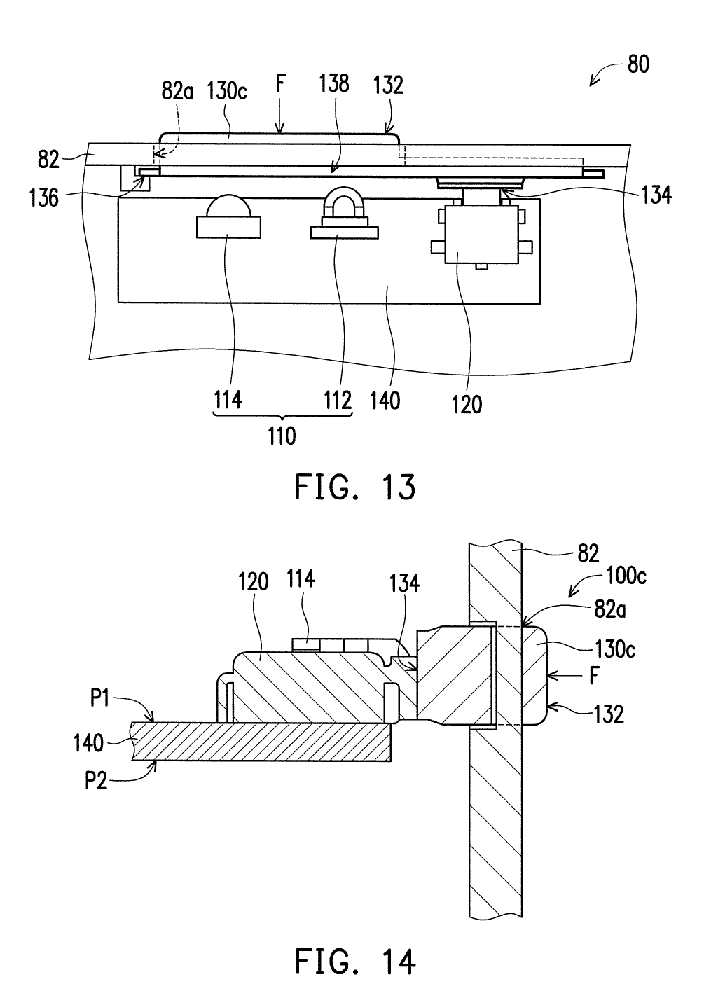

FIG. 13 is a partial top-view diagram of the electronic device of FIG. 11 and FIG. 14 is a cross-sectional diagram of the controlling assembly of FIG. 11 in angle of side-view. Referring to FIGS. 13 and 14, in the embodiment, the button 130c has also a pressing portion 132 and a contacting portion 134. The button 130c further includes a fixing end 136 and a free end 138. The fixing end 136 is fixed on the casing 82, and the pressing portion 132 and the contacting portion 134 are located at the free end 138.

In the embodiment, the pressing portion 132 is exposed at the casing 82 and adapted to accept an external force F, while the contacting portion 134 is located at an end of the button 130c and faces to the inner of the casing 82 to be corresponding to the pressing switch 120. In other words, the contacting portion 134 can be considered to be formed by that the button 130c located at the opening 82a extending into the casing 82 toward the side of the IR transmission module 110 corresponding to the opening 82a.

When the pressing portion 132 is pressed by the external force F and drives the contacting portion 134, the free end 138 can move relatively to the fixing end 136 to trigger the pressing switch 120 by the contacting portion 134. Thus, the user can apply the external force F onto the button 130c by pressing the pressing portion 132 exposed at the casing 82 so as to drive the contacting portion 134 of the button 130c to trigger the pressing switch 120 in pushing way or other ways by the movement of the free end 138 relatively to the fixing end 136.

It can be seen that the casing 82 of the electronic device 80 is able to enable the IR transmission module 110 to transmit or receive infrared light via an opening 82a and passing through the button 130c and makes the pressing switch 120 to be triggered by pressing the button 130c both through one opening 82a. The controlling assembly 100c thereby can reduce the number of the holes so that the electronic device 80 has fewer outward holes.

In summary, the invention provides a controlling assembly and an electronic device, in which the IR transmission module and the pressing switch are disposed in the casing of the electronic device and the IR transmission module is corresponding to the opening of the casing. The button is movable disposed on the casing and shields the opening and the button has transparency. The IR transmission module transmits or receives infrared light via the opening and passing through the button, and the pressing switch can be triggered by pressing the button. In the invention, only one opening is required to be disposed at the casing of the electronic device to make the IR transmission module and the pressing switch maintain the original function. In this way, the number of the holes can be reduced by the design of the controlling assembly so that the electronic device has fewer outward holes.

It will be apparent to those skilled in the art that the descriptions above are several preferred embodiments of the invention only, which does not limit the implementing range of the invention. Various modifications and variations can be made to the structure of the invention without departing from the scope or spirit of the invention. The claim scope of the invention is defined by the claims hereinafter.

What is claimed is:

1. A controlling assembly, adapted to be disposed at a casing, wherein the casing has an opening; the controlling assembly comprising:
an infrared transmission module, adapted to be disposed in the casing and corresponding to the opening;
a pressing switch, adapted to be disposed in the casing; and
a button, adapted to be movably disposed on the casing and shield the opening, wherein the button has transparency, the infrared transmission module is adapted to transmit or receive infrared light via the opening and passing through the button and the pressing switch is able to be triggered by pressing the button.

2. The controlling assembly as claimed in claim 1, further comprising:
a circuit board, adapted to be disposed in the casing, wherein the infrared transmission module and the pressing switch are disposed at the circuit board.

3. The controlling assembly as claimed in claim 2, wherein the circuit board has two side-surfaces opposite to each other, and the infrared transmission module and the pressing switch are respectively disposed at the two side-surfaces of the circuit board.

4. The controlling assembly as claimed in claim 2, wherein the circuit board has two side-surfaces opposite to each other, and the infrared transmission module and the pressing switch are disposed at one of the two side-surfaces of the circuit board.

5. The controlling assembly as claimed in claim 1, wherein the button has a pressing portion and a contacting portion, the pressing portion is adapted to be exposed at the casing and accept an external force, and when the pressing portion drives the contacting portion due to the pressing of the external force, the contacting portion triggers the pressing switch.

6. The controlling assembly as claimed in claim 5, wherein the button comprises a fixing end and a free end, the fixing end is fixed on the casing, the pressing portion and the contacting portion are located at the free end, and when the pressing portion drives the contacting portion due to the pressing of the external force, the free end is able to move relatively to the fixing end to make the contacting portion trigger the pressing switch.

7. The controlling assembly as claimed in claim 1, wherein portion of the button for shielding the opening is able to allow infrared light passing through but to block visible light.

8. An electronic device, comprising:
a casing, having an opening; and
a controlling assembly, disposed at the casing and comprising:
an infrared transmission module, disposed in the casing and corresponding to the opening;
a pressing switch, disposed in the casing; and
a button, movably disposed on the casing and shielding the opening, wherein the button has transparency, the infrared transmission module transmits or receives infrared light via the opening and passing through the button and the pressing switch is able to be triggered by pressing the button.

9. The electronic device as claimed in claim 8, wherein the controlling assembly further comprises a circuit board disposed in the casing, wherein the infrared transmission module and the pressing switch are disposed at the circuit board.

10. The electronic device as claimed in claim 9, wherein the circuit board has two side-surfaces opposite to each other, and the infrared transmission module and the pressing switch are respectively disposed at the two side-surfaces of the circuit board.

11. The electronic device as claimed in claim 9, wherein the circuit board has two side-surfaces opposite to each other, and the infrared transmission module and the pressing switch are disposed at one of the two side-surfaces of the circuit board.

12. The electronic device as claimed in claim 8, wherein the button has a pressing portion and a contacting portion, the pressing portion is exposed at the casing and adapted to accept an external force, and when the pressing portion drives the contacting portion due to the pressing of the external force, the contacting portion triggers the pressing switch.

13. The electronic device as claimed in claim 12, wherein the button comprises a fixing end and a free end, the fixing end is fixed on the casing, the pressing portion and the contacting portion are located at the free end, and when the pressing portion drives the contacting portion due to the pressing of the external force, the free end is able to move relatively to the fixing end to make the contacting portion trigger the pressing switch.

14. The electronic device as claimed in claim 8, wherein portion of the button for shielding the opening is able to allow infrared light passing through but to block visible light.
